(19) United States
(12) Patent Application Publication
(10) Pub. No.: US 2018/0079657 A1
(43) Pub. Date: Mar. 22, 2018

(54) METHOD AND APPARATUS FOR TREATING WATER

(71) Applicant: John C. Ellis, JR., Westbrookville, NY (US)

(72) Inventor: John C. Ellis, JR., Westbrookville, NY (US)

(21) Appl. No.: 15/825,474

(22) Filed: Nov. 29, 2017

Related U.S. Application Data
(63) Continuation of application No. 14/192,970, filed on Feb. 28, 2014, now abandoned.

(51) Int. Cl. C02F 1/04; B01D 5/00; C02F 1/78; C02F 1/00; C02F 103/02; C02F 1/20

(52) U.S. Cl. CPC C02F 1/04; B01D 5/006; B01D 5/0069; C02F 1/78; C02F 1/20; C02F 1/005; C02F 2103/026; C02F 2209/00; C02F 2303/04; B01D 5/0039

(57) ABSTRACT

A method and apparatus for treating water that results in water having a hydrogen bond angle of greater than 110°, preferably in a range of about 113° to about 114°. The method includes: channeling the water into a receptacle; devolatilizing and deaerating the water in the receptacle by using a condensing channel immersed in the water contained in the receptacle; channeling a portion of the water from the receptacle to a boiler via a feeder channel; heating the water in the boiler to generate steam; providing ozone to the steam in the boiler; and channeling the steam into the condensing channel. The apparatus includes a closed receptacle, a condensing channel housed in the receptacle, and a boiler in fluid communication with the receptacle. The boiler includes a boiler housing, an ozone generator and at least one heater having a total power of about 1500 watts.

This invention relates to a method and apparatus for treating water that may result in water having a hydrogen bond angle of greater than 110°, preferably in a range of 113°-114°.

### BACKGROUND

Ordinary water has a hydrogen bond angle of 104°. Ordinary distilled water has a hydrogen bond angle of only 101°. However, by increasing the hydrogen bond angle to greater than 110°, it is easier to split the water molecule into hydrogen and oxygen. Such results provide unexpected results as detailed below.

### SUMMARY

According to one embodiment of the present invention, a method for treating water may comprise: channeling the water into a receptacle; devolatilizing and deaerating the water in the receptacle by using a condensing channel immersed in the water contained in the receptacle; channeling a portion of the water from the receptacle to a boiler via a feeder channel; heating the water in the boiler to generate steam; providing ozone to the steam in the boiler; channeling the steam into the condensing channel immersed in the water contained in the receptacle; and flowing the water out of the condensing channel such that the water flowing out of the condensing channel has a hydrogen bond angle of greater than 110°. The boiler may comprise a boiler housing and one or two heaters housed in the boiler housing. The boiler housing may have an outer diameter of about 6.25 inches, and two substantially flat and parallel surfaces that are about 2.375 inches apart.

According to a preferred embodiment, the water flowing out of the condensing channel has a hydrogen bond angle in a range of about 113° to about 114°.

According to another embodiment of the present invention, an apparatus configured to treat water may comprise: a closed receptacle having an inlet and configured to contain a predetermined level of water; a condensing channel housed in the receptacle and having an outlet configured to channel water outside of the receptacle; and a boiler in fluid communication with the receptacle via a feeder channel. The boiler may comprise a boiler housing, an ozone generator and at least two heaters housed in the boiler housing. The two heaters may have a total power of about 1500 watts. An inlet of the condensing channel may protrude into the boiler housing. The apparatus is configured to produce water flowing out of the condensing channel that has a hydrogen bond angle of greater than 110°.

According to a preferred embodiment, the apparatus is configured to produce water flowing out of the condensing channel having a hydrogen bond angle in a range of about 113° to about 114°.

It is to be understood that both the foregoing general description and the following detailed descriptions are exemplary and explanatory only, and are not restrictive of the invention as claimed.

### BRIEF DESCRIPTION OF THE DRAWINGS

The features, aspects, and advantages of the present invention will become apparent from the description, appended claims, and the accompanying exemplary embodiments shown in the drawings, which are briefly described below.

FIG. 1 is a schematic view of a water molecule.

FIG. 2 is a process diagram showing the method of treating water according to one embodiment of the present invention.

FIG. 3 is a schematic top view of the apparatus for treating water according to one embodiment of the present invention.

FIG. 4 is a schematic side view of the apparatus of FIG. 3 taken along section line IV-IV.

FIG. 5 is a schematic side view of the apparatus of FIG. 3 taken along the section line V-V.

FIG. 6 is a schematic side view of the boiler of FIG. 3.

FIG. 7 is a schematic view showing a condensing channel according to one embodiment of the present invention.

FIG. 8 is a schematic view of the feeder channel according to one embodiment of the present invention.

### DETAILED DESCRIPTION

Various embodiments of the present invention will be explained with reference to the accompanying drawings.

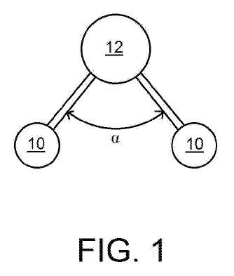

FIG. 1 is a schematic view of a water molecule containing two hydrogen atoms 10 and one oxygen atom 12. Ordinary water has a hydrogen bond angle α of 104°. Ordinary distilled water has a hydrogen bond angle α of only 101°. By comparison, hydrogen peroxide has a bond angle of 111° and ozone has a bond angle of 116°. Ordinary filtered or distilled water cannot even stop e-coli.

By increasing the hydrogen bond angle α to greater than 110°, it is easier to split the water molecule into hydrogen and oxygen. Drinking such water helps improve general blood circulation to the extremities, which inhibits the skin aging process and aids in disease prevention or treatment. Because human blood is 94% water, when the water with the higher hydrogen bond angles produced by the apparatuses and/or methods disclosed herein is ingested and enters the blood stream, the hydrogen burns up the impurities and markers in the blood stream. For example, a person's face shows all the progressive signs of aging as the carotid artery starts to clog. If the blood circulation is increased through the carotid artery, the signs of aging diminish. Furthermore, with the removal of certain carcinogenic markers, the progression of certain cancers can be diminished or reversed.

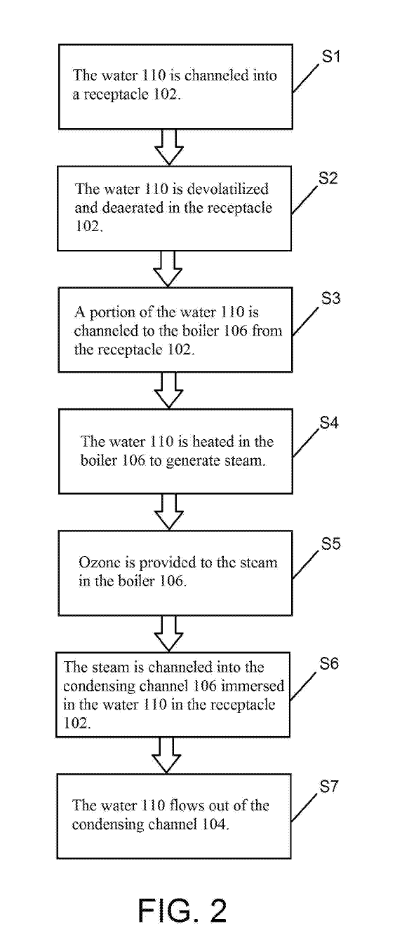

FIG. 2 shows a method of treating water according one embodiment of the present invention. First, water 110 is channeled into a receptacle 102 at step S1. Next, the water is devolatilized and deaerated in the receptacle 102 at step S2 by using a condensing channel 104 immersed in the water 110 contained in the receptacle 102. At step S3, a portion of the water 110 is channeled to the boiler 106 from the receptacle 102 via a feeder channel 126. At step S4, the water 110 is heated in the boiler 106 to generate steam. At step S5, ozone is provided to the steam in the boiler 106. At step S6, the steam is channeled into the condensing channel 104 immersed in the water 110 contained in the receptacle 102. At step S7, the water 110 flows out of the condensing channel 104 in which the exiting water has a hydrogen bond angle of greater than 110°.

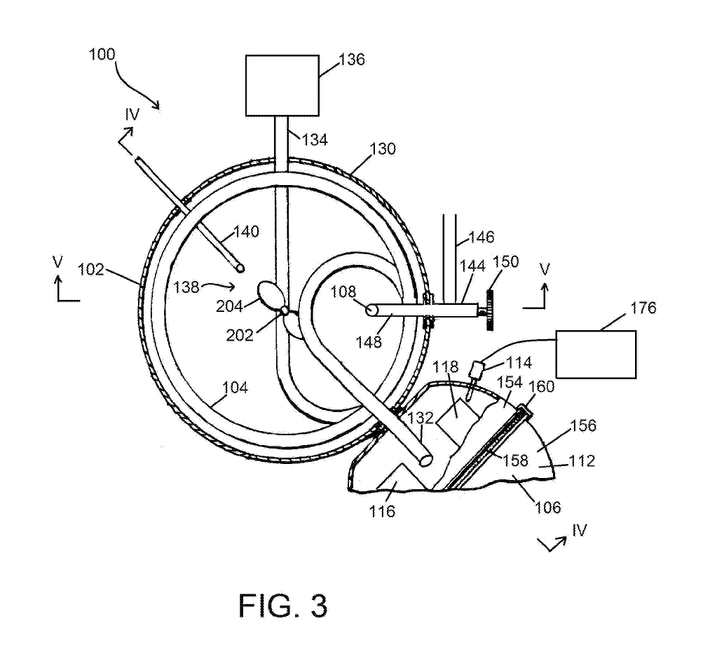

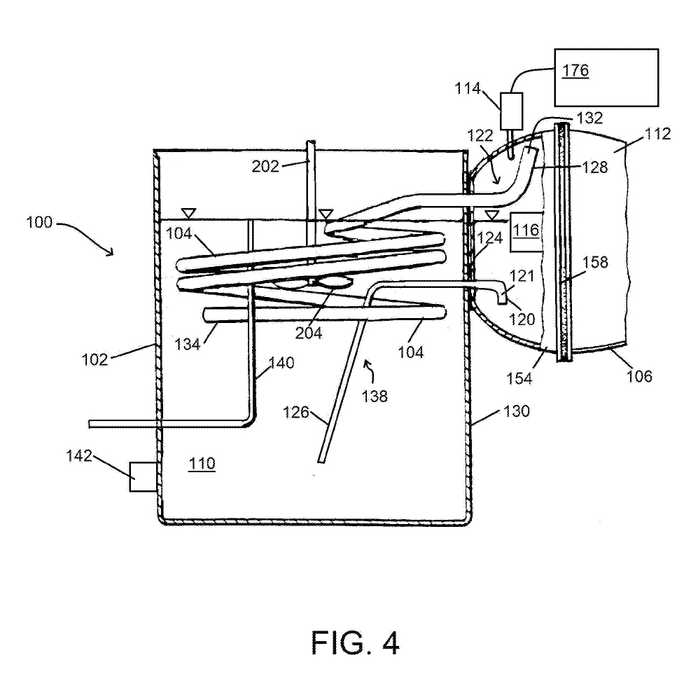

Referring now to FIGS. 3 and 4, the apparatus for treating water 100 may comprise a closed receptacle 102, a condensing channel 104, and a boiler 106.

The closed receptacle 102 may be, for example, a cylindrical tank container. However, other shapes of container may be used, such as containers that are polygonal in cross section. The receptacle 102 may have a pair of handles (not shown) secured to the circumferential side thereof. The receptacle may also have an inlet 108 configured to permit the inflow of water 110. The receptacle may be any suitable material, such as, for example, stainless steel.

A boiler 106 may include a boiler housing 112, an ozone generator 114, and at least two heaters 116 and 118. The boiler housing 112 is affixed to the side of the receptacle 102 by any suitable mechanism such as by welding, brazing, screws with sealing, or the fluid connectors 120 and 122.

According to one embodiment, the fluid connector 120 includes an elbow 121 having a shoulder (not shown) and a threaded shank (not shown) extending through cooperating openings in the wall 124 of the boiler housing 112 and the wall 130 of the receptacle 102. A nut (not shown) may engage the shank of the fluid connector 120 and together with a resilient washer provide a water-tight seal for both the receptacle 102 and the boiler 106. A feeder channel 126 is fixedly coupled to the fluid connector 120 by a nut (not shown) so that the water within receptacle 102 will automatically feed into the boiler 106 until the water level within boiler 106 corresponds to the water level inside the receptacle 102. Examples of suitable fluid connections for any of the channels, tubing, fittings, or the like as described herein may be found in U.S. Pat. No. 6,409,888, which is incorporated by reference in its entirety. Of course, the fluid connections may be made in an suitable fashion, such as, for example, welding, brazing, clamping, and the like. It will also be observed that the water level is maintained at a level adequate to effect total or at least substantial immersion of the heaters 116 and 118 in the water of boiler 106. The feeder channel 126 acts as a water inlet conduit. The feeder channel 126 may be made of any suitable material such as stainless steel, copper, a copper alloy, or the like. The feeder channel may, for example, be a tube having a diameter of about ⅜ inches.

The fluid connector 122 may serve as a steam outlet for the boiler 106 into the condensing channel 104. The fluid connector 122 may include an outlet pipe 128, a threaded shank (not shown) extending through the wall 130 of the receptacle 102 and the boiler housing 112 and secured by a nut (not shown). A sealing washer may be disposed between the receptacle 102 and the boiler 106 to provide a watertight connection. The fluid connector 112 may act as an inlet 132 for the condensing channel 104. Alternatively, the fluid connector 122 may sealingly connect to the inlet 132.

The condensing channel 104 may be in the form of a coiled tube of metal such as stainless steel, copper or the like in which its inlet 132 protrudes into the boiler housing 112. The outlet 134 of the condensing channel 104 may have a fitting (not shown) extending through the wall 130 of the receptacle 102. The condensing channel 104 may be a condensing coil having a diameter of about ½ inches. The contending coil forms a cylindrical region 138 at the center of the receptacle 102. The receptacle 102 may further include an overflow pipe 140 which is connected to a fitting sealed to the wall 130 of the receptacle and a drain cock 142 for draining water from the receptacle. The drain cock 142 may be useful for cleaning and maintenance of the apparatus 100.

Optionally, a filter 136 may be in fluid communication with the outlet 134. The filter 136 may absorb any organic materials that are carried over with the condensate. According to one embodiment of the present invention, the filter 136 is an oversized carbon filter. According to another embodiment of the present invention, the filter 136 may be omitted.

The inlet 108 of the receptacle 102 may include a water inlet valve 144 at the upper portion of the receptacle 102. The water inlet valve 144 may include an inlet 146, an outlet 148 and a hand-wheel 150 for regulating the water supply in order to maintain an appropriate supply of water to the receptacle 102. However, the valve 144 may take any suitable form such as an electrically controlled valve, a flow meter, or other suitable flow control mechanism.

FIG. 4 shows the boiler 106. The boiler 106 may include a boiler housing 112, an ozone generator 114, and at least two heaters 116 and 118. The boiler housing 112 may have a volume that is smaller than a volume of the receptacle 102. The boiler housing 112 may have an outer diameter of about 6.25 inches, and two substantially flat and parallel surfaces 172 and 174 that are about 2.375 inches apart.

The boiler housing 112 comprises two housing elements 154 and 156. The wall 152 is disposed between the housing elements 154 and 156 includes a peripheral seal 158 which is releasably clamped between the outer rims of the housing elements 154 and 156 by clips 160 at the periphery of the boiler housing 112. This arrangement completely seals the boiler 106 formed by the housing elements 154 and 156 and the wall 152. The whole boiler 106 can be readily disassembled for cleaning.

The heaters 116 and 118 are housed in the boiler housing 112, carried by the wall 152, and are connected in series by a lead 162 connecting one terminal of one heater to one terminal of the other heater. The power line 164 has one lead 166 connected to the other terminal of the heater 118 while the second lead 168 is connected through a thermostat 170 to the other terminal of the heater 116. The thermostat 170 may be mounted on a bracket (not shown) in close proximity to the heaters 116 and 118. In the event the heater 116 reaches a temperature above the normal operating temperature, the thermostat 170 will operate to open the circuit and de-energize both heaters 116 and 118. It is evident, however, that the heaters 116 and 118 could be arranged for parallel operating. The two heaters 116 and 118 have a total power of about 1500 watts. According to one embodiment, each heater 116 and 118 has a power of 750 watts. According to another embodiment, one heater may be used in lieu of the two heaters 116 and 118 in which the one heater, for example, may be one rectangular heater having a total power of 1500 watts with the same combined envelope size as the two heaters 116 and 118 such that the heater fits into the boiler 106.

The ozone generator 114 may be inserted into the boiler 106 through a port in the housing element 154. The ozone generator 114 is powered by transformer 176. It is not necessary, however, to have a separate power supply for the ozone generator 114. The ozone generator may be powered by the same power supply used to operate heaters 116 and 118.

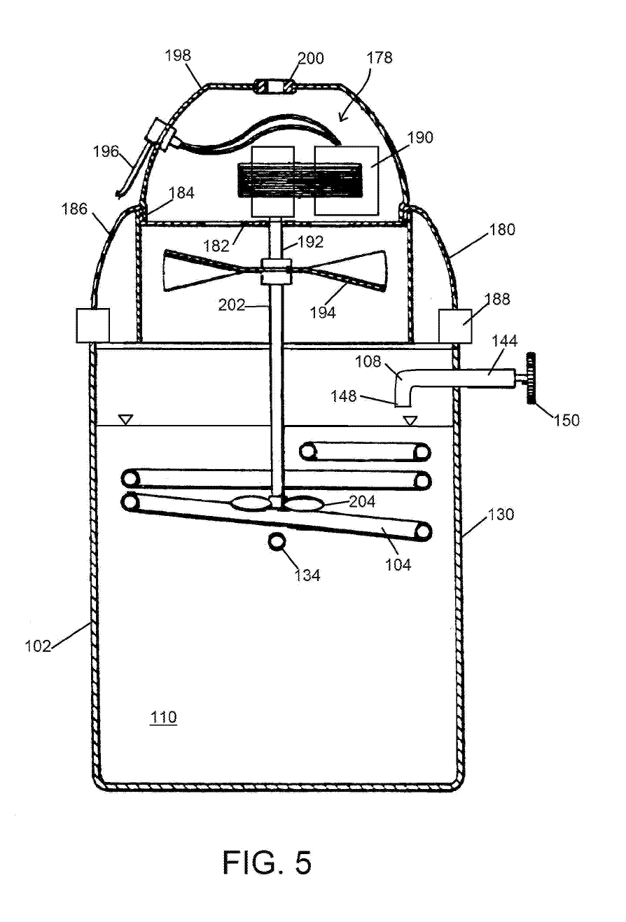

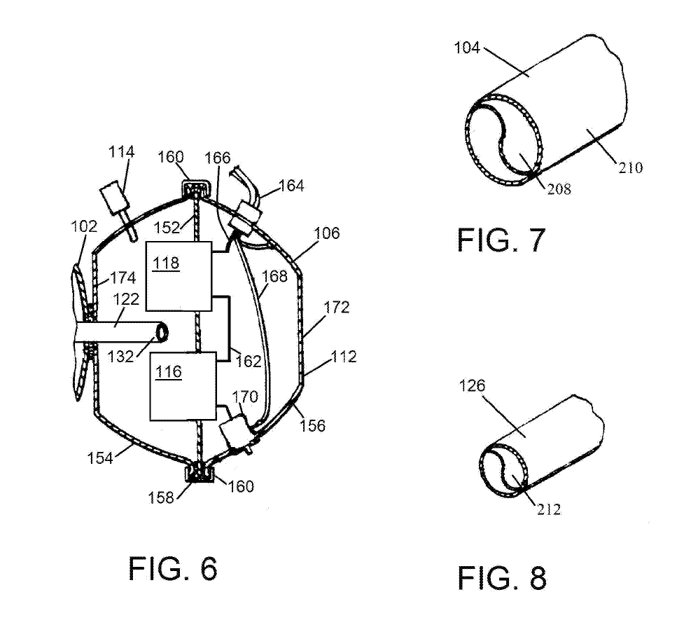

According to one embodiment of the present invention, a forced air circulation system 178 may assist in the removal of steam and undesirable vapors liberated from the water within receptacle 102. The forced air circulation system 178 shown in FIG. 5 may comprise an inverted dished cover 180 over the receptacle 10 which includes a flat upper wall 182 that is perforated or apertured, an upwardly extending peripheral wall 184 and a downwardly curved peripheral wall 186. The lower peripheral edge of the wall 186 carries three or more diagonally disposed rollers 188 each having spaced discs rotatably carried by a shaft. The discs engage a rolled edge (not shown) of the receptacle 102 and accordingly provide an annular vent or opening between the cover 180 and the top edge of the receptacle 102. For the particulars of the rollers, refer to U.S. Pat. No. 6,409,888, which is incorporated herein by reference in its entirety.

The flat apertured wall 182 of the air circulation system 178 supports an electric motor 190 which powers a shaft 192 extending through the perforated wall 182. A fan 194 is mounted on the shaft 192. Power is fed to the motor 190 by a cable 196 connected in a conventional manner to the motor 190. If desired, a switch may be provided for the operation of the fan 194. The fan motor 190 is covered by a vented dome-shaped housing 198 that is securely fitted to the cover 180 and is attached thereto by any suitable mechanism, such as, for example, clamps, screws, or the like. The dome-shaped housing 198 may, for example, frictionally engage the peripheral wall 184 of the cover 180.

In one mode of fan operation, air is drawn into the air circulation system 178 through an opening 200 in the dome-shaped housing 198 and then down through the perforated wall 182 whereupon it is directed downwardly over the water in the receptacle 102 and thereafter is discharged through the annular opening between the receptacle 102 and the cover 180. In the reverse mode of fan operation, the fan 194 draws air in through the annular opening between the receptacle 102 and the cover 180 up through perforated wall 182 and opening out through the vent 200 in the dome-shaped housing 198.

A stirrer rod 202 may optionally extend from an integral connection with the shaft 192 at the hub of fan 194 preferably but not necessarily axially of the cylindrical region 138 inside of the condensing channel 104 and terminates at stirrer blades 204 immersed in the water contained in the closed receptacle 102. The depth of immersion for the stirrer blades 204 is not critical, but preferably, they are not deeper than the bottom of condensing channel 104. According to one embodiment, the stirrer rod 202 may be positioned modestly off-center to avoid interference with the outlet bend of condensing channel 104.

In the operation of the apparatus 100, a method for treating water may generally comprise channeling the water into the receptacle 102; devolatilizing and deaerating the water in the receptacle 102 by using the condensing channel 104 immersed in the water 110 contained in the receptacle 102; channeling a portion of the water 110 from the receptacle 102 to the boiler 106 via a feeder channel 126; heating the water 110 in the boiler 106 to generate steam; providing ozone to the steam in the boiler 106; channeling the steam into the condensing channel 106 immersed in the water 110 contained in the receptacle 102; and flowing the water 110 out of the condensing channel 104 such that the water flowing out of the condensing channel 104 has a hydrogen bond angle of greater than 110°, as previously mentioned with reference to FIG. 2. In line with this general method, the following provides particulars that may be used to implement the above method, but the method according to the present invention is not limited to these particulars.

The receptacle 102 and the boiler 106 are first filled with water 110 to a level at least substantially covering the heaters 116 and 118. When filling the receptacle 102, water will automatically flow through the feeder channel 126 into the boiler 106 so that ultimately the level of the water in the receptacle 102 will be about the same as the water level in the boiler 106. According to one embodiment, the boiler is about half full to allow enough space for steam generation above the water line. If the boiler is any larger, using the relationship between the above elements, it may take too long for the heaters 116 and 118 to bring the water up to boiling again after each cycle.

When energy is supplied to the heaters 116 and 118, the water within the boiler 106 will boil. Oxygen in the air above the water is turned to ozone by the ozone generator 114. Steam generated from the heaters 116 and 118 rises through the ozone and enters the fluid connector 122 at the outlet pipe 128.

The steam then flows through the condensing channel 104 to be condensed therein. The condensed steam will then discharge through the optional filter 136 as the distillate (liquid) product from the outlet 134 of the condensing channel 104. When first operating the apparatus 100, it may be generally desirable to discard the distillate product until the water inside the receptacle 102 has attained a normal operating temperature which preferably is about 180° F. to about 190° F. (which may be rapidly attained). The heaters 116 and 118 have a total power of 1500 watts and are designed to heat the water within the boiler 106 at a rate faster than the condensing channel 104 can accommodate the steam produced. Accordingly, a head of steam is developed within the boiler 106 and the steam pressure will force liquid from the boiler 106 back through the feeder channel 126 into the receptacle 102 thereby relieving the steam pressure. The flow of the water from the boiler 106 into the feeder channel 126 generates a vacuum in the boiler 106. The vacuum causes air to be drawn through the optional filter 136 into the outlet 134 of the condensing channel 104, traveling through the condensing channel 126 and exiting in the boiler 106 via the fluid connector 122 at the outlet pipe 128 and thereby providing fresh oxygen for the ozone generator 114. As soon as the steam pressure within the boiler is relieved, water will again flow through the feeder channel 126 back into the boiler 106 with the result that there will be a periodic reversal of water flow through the feeder channel 126 and air flow through the condensing channel 104. With the above set of conditions, the apparatus recycles about 3 times per minute. This pulsating action results in a more rapid increase in temperature of the water within the receptacle 102 by contributing heat over and above the heat imparted to the reservoir water by the action of the condensing channel 104. It also results in a constant renewing of ozone in the boiler 106. The temperature of the water, however, is always below the boiling temperature of the water in boiler 106 so that distillate will be condensed in the condensing channel 104. Preferably the water should be kept in the range of about 180° F. to about 190° F. This temperature level will boil off undesirable components from the reservoir water (prior to actual distillation thereof), and also serves to operate the condensing channel 104 adequately. To maintain proper operation of the apparatus 100, a substantial proportion of the feed water which enters at the inlet 108 ultimately is discharged as overflow through the overflow pipe 140 and the outlet 134.

If the filter 136 is provided in the apparatus 100, as in accordance with one embodiment of the present invention, a pulse of steam pressure from the boiler 106 passes through the condensing channel 104 in a forward direction during a steam generation pulse, sending the condensate out through the filter 136. During the reverse suction pulse, the air is drawn into the filter 136, through the condensing channel 104, into the boiler 106. Thus, the filter 136 acts as much to filter air drawn into the condensing channel 104, as it does to filter distillate leaving the condensing channel 104.

Manifestly, the pulses are not equal in their effect. The steam is being generated in the boiler 106, then is condensed in condensing channel 104. The distillate is discharged at the outlet 134 through the filter 136. A net outflow movement of distilled water through the filter 136 results. At the same time, a small net inflow of air into the filter 136 and the condensing channel 104 results. The distillate, for example, at about 190° F. to about 195° F., is hot enough to heat the filter 136 and prevents microbial contamination of the filter 136. This means that air which enters the filter 136 during the suction pulses is retained therein and becomes sterilized by the hot filter before entering the condensing channel 104 and/or becoming absorbed in the distillate. The reason for providing the filter 136 that is oversized is precisely to increase the residence time therein of the inflowing air. Overall, the result is that air heated and sterilized in the filter 136 partially aerates the distilled water improving the palatability thereof.

According to another embodiment of the present invention, a deflector 208 may optionally be placed inside the condensing channel 104 so as to generate spiral flow movement of steam and condensate to the tube wall 210, as seen in FIG. 7. Thus, the spiral flow movement may help maintain the temperature across the condenser channel 104. Also, the flow inside the condensing channel 104 may become more turbulent thereby helping the heat exchange across the tube wall 210.

According to another embodiment of the present invention, as seen in FIG. 8, a deflector 212 may be provided in the feeder channel 126 connecting the receptacle 102 to the boiler 106. The purpose of the deflector 212 may create turbulent mixing of the water so as to avoid any temperature stratification either in the receptacle 102 or in the boiler 106.

Using the apparatus and/or methods described herein, the water flowing out of the condensing channel has a hydrogen bond angle of greater than 110°. For example, the water will have a hydrogen bond angle of about 113° to about 114°, preferably 113.8°. This is an unexpected result, which can be observed using a tunneling electron microscope. At these bond angles, it takes less energy to split water into hydrogen and oxygen using a hydrogen generator. For example, Hyfusion.com manufactures hydrogen generators for trucks that normally draw 31 amps, but it takes only 20 drops of water that has been treated in accordance with the apparatuses and/or methods disclosed herein added to the ordinary water in the reservoir to bring the ammeter down from 31 amps to about ½ amp. This is proof that the hydrogen bond angle has changed because it takes less energy to split the water molecule at about 114° than at 104°.

As previously mentioned, ordinary water has a hydrogen bond angle α of 104° while ordinary distilled water has a hydrogen bond angle α of only 101°. Ordinary filtered or distilled water cannot even stop e-coli. In contrast, the cooling water (which can be made faster than the distilled water that has been back and forth between the boiler and the condenser) was used to get rid of the smell of e-coli, noroviruses, etc. at La Salle, Colo. when 1000 gallons of the water was sprayed on a 5 acre waste lagoon with over 10 million gallons of e-coli. The smell was gone in 24 hours, which saved the town $10,000/day in fines from the state and the costs related to building a waste treatment plant (which would be millions of dollars).

Furthermore, it is noted that every virus and bacteria has a different destruction time and ordinary products do not allow enough time to destroy them. For example, viruses are so tiny they will go through anything, even a person's skin. As a result, they may go through any water filter and they are so light that they may travel with steam into the distilled water. Using the lab standard for pure water of 0.1 ppm TDS (Total Dissolved Solids), the apparatus and/or methods described herein produce water that goes down to less than 0.07 ppm as compared to the best on the market (which goes down to 0.14 ppm). These results can be achieved by lowering the steam velocity and pollutant carryover, by starting and stopping the boiling about 3 times/minute as the water goes back and forth from the condenser tank to the boiler. Since the water goes back and forth 100 or so times/gallon (rather than just once like an ordinary distiller or filter), this allows for plenty of destruction time, which can be advantageous as deadly viruses mutate and get stronger.

As previously mentioned, because human blood is 94% water, when the water with the higher hydrogen bond angles produced by the apparatuses and/or methods disclosed herein is ingested and enters the blood stream, the hydrogen burns up the impurities and markers in the blood stream. With the removal of certain carcinogenic markers, the progression of certain cancers can be diminished or reversed. For example, research conducted to see which water gave the best blood flow showed that nothing comes close to the water produced by the method and/or systems used herein. Also, the water produced by the method and/or systems used herein has helped many diabetics in danger of amputation. Further, if a copper alloy tube having a diameter of about ⅜ inches is used as the feeder channel 126, highly infectious noroviruses (such noroviruses have made people recently sick on cruise ships, for example) may be destroyed because of the water going back and forth from the boiler to the condenser about 3 times per minute with these parameters.

As utilized herein, the terms “approximately,” “about,” “substantially,” and similar terms are intended to have a meaning in harmony with the common and accepted usage by those of ordinary skill in the art to which the subject matter of this disclosure pertains. For example, the terms “approximately,” “about,” “substantially,” and similar terms may mean +/−10% of the value or term they modify, preferably +/−5% of the value of term they modify.

Besides those embodiments depicted in the figures and described in the above description, other embodiments of the present invention are also contemplated. For example, any single feature of one embodiment of the present invention may be used in any other embodiment of the present invention. For example, the method for treating water and/or the apparatus configured to treat water may comprise any one or more of the following features (1)-(24) in any combination:

(1) channeling the water into a receptacle;

(2) devolatilizing and deaerating the water in the receptacle by using a condensing channel immersed in the water contained in the receptacle;

(3) channeling a portion of the water from the receptacle to a boiler via a feeder channel;

(4) heating the water in the boiler to generate steam;

(5) providing ozone to the steam in the boiler;

(6) channeling the steam into the condensing channel immersed in the water contained in the receptacle;

(7) flowing the water out of the condensing channel such that the water flowing out of the condensing channel has a hydrogen bond angle of greater than 110°;

(8) a predetermined level of the water contained in the receptacle is maintained such that a temperature of the water in the receptacle is in a range of about 180° F. to about 190° F.;

(9) the feeder channel is a feeder tube having a diameter of about ⅜ inches;

(10) the condensing channel is a condensing coil having a diameter of about ½ inches;

(11) the boiler comprises a boiler housing and one or two heaters housed in the boiler housing;

(12) the one or two heaters have a total power of about 1500 watts;

(13) the boiler housing has a volume that is smaller than a volume of the receptacle;

(14) the boiler housing has an outer diameter of about 6.25 inches, and two substantially flat and parallel surfaces that are about 2.375 inches apart;

(15) the boiler periodically generates more steam than can be accommodated by the condensing channel thereby causing a pulsation such that the water is forced to flow out of the boiler back into the receptacle by steam pressure, and the steam pressure pulse is dissipated such that water flows back into the boiler from the receptacle;

(16) the pulsation also causes periodic flow of condensate out of the condensing channel and periodic flow of air into the boiler;

(17) the water flowing out of the condensing channel has a hydrogen bond angle in a range of about 113° to about 114°;

(18) a closed receptacle having an inlet and configured to contain a predetermined level of water;

(19) a condensing channel housed in the receptacle and having an outlet configured to channel water outside of the receptacle;

(20) a boiler in fluid communication with the receptacle via a feeder channel;

(21) the boiler comprises a boiler housing, an ozone generator and at least two heaters housed in the boiler housing;

(22) an inlet of the condensing channel protrudes into the boiler housing;

(23) the apparatus is configured to produce water flowing out of the condensing channel that has a hydrogen bond angle of greater than 110°; and/or

(24) the apparatus is configured to produce water flowing out of the condensing channel having a hydrogen bond angle in a range of about 113° to about 114°.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. A method for treating water comprising:
channeling the water into a receptacle;
devolatilizing and deaerating the water in the receptacle by using a condensing channel immersed in the water contained in the receptacle;
channeling a portion of the water from the receptacle to a boiler via a feeder channel, wherein the boiler comprises a boiler housing and one or two heaters housed in the boiler housing, wherein the boiler housing has an outer diameter of about 6.25 inches and two substantially flat and parallel surfaces that are about 2.375 inches apart;
heating the water in the boiler to generate steam;
providing ozone to the steam in the boiler;
channeling the steam into the condensing channel immersed in the water contained in the receptacle; and
flowing the water out of the condensing channel.

2. The method according to claim 1, wherein a predetermined level of the water contained in the receptacle is maintained such that a temperature of the water in the receptacle is in a range of about 180° F. to about 190° F.

3. The method according to claim 1, wherein the feeder channel is a feeder tube having a diameter of about ⅜ inches.

4. The method according to claim 1, wherein the condensing channel is a condensing coil having a diameter of about ½ inches.

5. The method according to claim 1, wherein the one or two heaters have a total power of about 1500 watts.

6. The method according to claim 5, wherein the boiler housing has a volume that is smaller than a volume of the receptacle.

7. The method according to claim 1, wherein the boiler periodically generates more steam than can be accommodated by the condensing channel thereby causing a pulsation such that the water is forced to flow out of the boiler back into the receptacle by steam pressure, and the steam pressure pulse is dissipated such that water flows back into the boiler from the receptacle, and wherein the pulsation also causes periodic flow of condensate out of the condensing channel and periodic flow of air into the boiler.

8-13. (canceled)
